(19) United States
(12) Patent Application Publication
(10) Pub. No.: US 2024/0426013 A1
(43) Pub. Date: Dec. 26, 2024

(54) SYSTEM AND METHOD OF SELECTIVE ELECTRODEPOSITION FOR METAL RECYCLING

(71) Applicant: The Board of Trustees of the University of Illinois, Urbana, IL (US)

(72) Inventors: Xiao SU, Champaign, IL (US); Kwiyong KIM, Champaign, IL (US)

(73) Assignee: The Board of Trustees of the University of Illinois, Urbana, IL (US)

(21) Appl. No.: 18/698,241

(22) PCT Filed: Oct. 4, 2022
(86) PCT No.: PCT/US2022/045674

§ 371 Date: Apr. 3, 2024

Related U.S. Application Data
(60) Provisional application No. 63/253,476, filed on Oct. 7, 2021.

(51) Int. Cl. C25C 1/08; C25C 7/08; C25D 3/12

(52) U.S. Cl. CPC C25C 1/08; C25C 7/08; C25D 3/12

(57) ABSTRACT

A system for selective electrodeposition for metal recycling includes an electrochemical cell comprising: a fluid including first and second transition metals and a salt at a molar concentration of greater than 1 M; a working electrode in contact with the fluid. where the working electrode has a surface coated with a positively charged polyelectrolyte: and a counter electrode in contact with the fluid and spaced apart from the working electrode. The system also includes a power supply electrically connected to the working and counter electrodes.

### RELATED APPLICATION

The present patent document claims the benefit of priority under 35 U.S.C. 119(e) to U.S. Provisional Patent Application 63/253,476, which was filed on Oct. 7, 2021, and is hereby incorporated by reference in its entirety.

### FEDERALLY FUNDED RESEARCH OR DEVELOPMENT

This invention was made with government support under subaward 1(GG017077-01) awarded by the Department of Energy. The government has certain rights in the invention.

### TECHNICAL FIELD

The present disclosure is related generally to electrodeposition and more particularly to selective electrodeposition for recovering metal elements from waste batteries, mining waste, and other industrial waste sources.

### BACKGROUND

Worldwide consumption of electronic devices has led to a sharp increase in waste batteries. Spent lithium-ion batteries (LIBs) contain critical elements, such as lithium (5-8%), cobalt (5-20%), nickel (5-10%), and manganese (10-15%), and nickel-metal hydride batteries also possess high concentrations of nickel (36-42%) and cobalt (3-5%). The future demand for critical elements, especially cobalt and nickel, has been predicted to exceed identified reserves, and there are increasing geographical, environmental, and political pressures related to primary mining operations. Thus, there is a strong incentive to develop sustainable strategies to recover critical elements from the potentially valuable secondary resources.

Achieving selectivity is a key to sustainable metal recycling. However, metals with close reduction potentials present a fundamental challenge for selective electrodeposition, especially for critical elements such as cobalt and nickel.

### BRIEF DESCRIPTION OF THE DRAWINGS

FIG. 1 is a flow chart showing exemplary steps in a selective deposition process for metal separation and recovery.

FIG. 2 is a schematic representation of potential-dependent selectivity tuning during electrodeposition enabled by synergistic electrolyte and interfacial control.

FIG. 3 shows a linear sweep voltammogram (LSV) of a single metal salt of 10 mM Co(II) or Ni(II) in 0.1 M Li₂SO₄ at a scan rate of 5 mV s⁻¹.

FIG. 4 shows a LSV of a single metal salt of 10 mM Co(II) or Ni(II) in 0.1 M LiCl at a scan rate of 5 mV s⁻¹.

FIG. 5 shows surface Co/Ni ratios on the electrodeposit formed from a working fluid comprising a binary mixture of 10 mM Co(II) +Ni(II) in the background electrolyte of 0.1 M Li₂SO₄.

FIG. 6 shows surface Co/Ni ratios on the electrodeposit formed from a working fluid comprising a binary mixture of 10 mM Co(II)+Ni(II) in the background electrolyte of 0.1 M LiCl.

FIG. 7 shows a LSV of a single metal salt of 10 mM Co(II) or Ni(II) in 10 M LiCl at a scan rate of 5 mV s⁻¹.

FIG. 8 shows surface Co/Ni ratios on the electrodeposit formed from a working fluid comprising a binary mixture of 10 mM Co(II)+Ni(II) in the background electrolyte of 10 M LiCl.

FIG. 9 shows surface Co/Ni ratios on the electrodeposits formed from a working fluid comprising a binary mixture of 10 mM Co(II)+Ni(II) and 100 mM Co(II)+Ni(II) in 10 M LiCl; the substrate (or working electrode) was copper foil.

FIG. 10 shows the effect of applied potential on the surface Co/Ni ratios on the electrodeposits formed in the binary mixture of 100 mM Co(II)+Ni(II) in 10 M LiCl using various substrates as a working electrode.

FIG. 11A shows the effect of loading level of the positively charged polyelectrolyte (PDADMA in this example) on the surface Co/Ni ratio of the electrodeposit formed with a cathodic potential of −0.725 V for 0.5 h.

FIG. 11B shows the actual amount of cobalt and nickel electrodeposited using a cathodic potential of −0.725 V for 0.5 h.

FIG. 12A shows LSVs of a single metal salt of 10 mM Co(II) or Ni(II) in 10M LiCl using pristine Cu and PDADMA-loaded Cu (PDADMA loading: 0.75 mg cm⁻²) at a scan rate of 5 mV s⁻¹.

FIG. 12B shows the actual amount of cobalt and nickel electrodeposited from a working fluid comprising a single metal salt of 10 mM Co(II) or Ni(II) in 10 M LiCl using pristine Cu and PDADMA-loaded Cu (PDADMA loading: 0.75 mg cm⁻²), where −0.725 V was applied for 0.5 h.

FIG. 13A shows a LSV of pristine copper foil during cathodic sweep in a working fluid comprising 10 mM Co(II) in 10 M LiCl in the absence of PDADMA; the scan rate was 5 mV s⁻¹ and there was no agitation.

FIG. 13B shows a LSV of pristine copper foil during cathodic sweep in a working fluid comprising 10 mM Co(II) in 10 M LiCl in the presence of 0.01 wt. % PDADMA; the scan rate was 5 mV s⁻¹ and there was no agitation.

FIG. 13C shows a LSV of pristine copper foil during cathodic sweep in a working fluid comprising 10 mM Ni(II) in 10 M LiCl in the absence of PDADMA; the scan rate was 5 mV s⁻¹ and there was no agitation.

FIG. 13D shows a LSV of pristine copper foil during cathodic sweep in a working fluid comprising 10 mM Ni(II) in 10 M LiCl in the presence of 0.01 wt. % PDADMA; the scan rate was 5 mV s⁻¹ and there was no agitation.

FIG. 14 shows Tafel plots of a single metal salt of 10 mM Co(II) or Ni(II) in 10 M LiCl using pristine Cu and PDADMA-loaded Cu (PDADMA loading: 0.75 mg cm⁻²).

FIG. 15 shows the effect of a background electrolyte and interfacial polymer on surface Ni/Co ratio at a nickel-favored potential of −0.6 V.

FIG. 16 shows the effect of a background electrolyte and interfacial polymer on surface Co/Ni ratio at a cobalt-favored potential of −0.725 V.

FIG. 17A shows the potential during electrodeposition and stripping of cobalt and nickel from a PDADMA/Cu electrode (PDADMA loading: 0.07 mg cm⁻²), where electrodeposition was carried out at −0.725 V in a working fluid comprising 100 mM Co(II)+Ni(II) in 10 M LiCl and stripping was carried out at −0.08 V in a stripping solution comprising 5 mM NaNO₃, whose pH was adjusted to 3 using HCl.

FIG. 17B shows the current during the electrodeposition and stripping of FIG. 17A.

FIG. 17C shows stripping efficiency of the electrodeposited cobalt and nickel (left y-axis) and the amount of stripped cobalt and nickel (right y-axis) during stripping at −0.08 V.

FIG. 18A shows the potential during electrodeposition and stripping of cobalt and nickel from a PDADMA/Cu electrode (PDADMA loading: 0.75 mg cm⁻²). Electrodeposition was carried out at −0.725 V in a working fluid comprising 100 mM Co(II)+Ni(II) in 10 M LiCl and stripping was carried out at −0.08 V in a stripping solution comprising 5 mM NaNO₃, whose pH was adjusted to 3 using HCl.

FIG. 18B shows the current during the electrodeposition and stripping of FIG. 18A.

FIG. 18C shows stripping efficiency of the electrodeposited cobalt and nickel (left y-axis) and the amount of stripped cobalt and nickel (right y-axis) during stripping at −0.08 V.

FIG. 19A shows data from an electrochemical quartz crystal microbalance (EQCM) study of electrodeposition-stripping on a Cu-coated quartz crystal, where potential is plotted as a function of time during the electrodeposition and stripping of cobalt and nickel; electrodeposition was carried out at −0.725 V in a working fluid comprising 100 mM Co(II)+Ni(II) in 10 M LiCl and stripping was carried out at −0.08 V in a stripping solution comprising 5 mM NaNO₃, whose pH was adjusted to 3 using HCl.

FIG. 19B shows data from an EQCM study of electrodeposition-stripping on a Cu-coated quartz crystal, where current is plotted as a function of time during the electrodeposition and stripping of cobalt and nickel; electrodeposition was carried out as described in reference to FIG. 19A.

FIG. 19C shows data from an EQCM study of electrodeposition-stripping on a Cu-coated quartz crystal, where change in mass is plotted as a function of time during the electrodeposition and stripping of cobalt and nickel; electrodeposition was carried out as described in reference to FIG. 19A.

FIG. 20A shows data from an EQCM study of electrodeposition-stripping on a PDADMA/Cu-coated quartz crystal (PDADMA loading: 0.75 mg cm⁻²), where potential is plotted as a function of time during the electrodeposition and stripping of cobalt and nickel; electrodeposition was carried out at −0.725 V in a working fluid comprising 100 mM Co(II)+Ni(II) in 10 M LiCl and stripping was carried out at −0.08 V in a stripping solution comprising 5 mM NaNO₃, whose pH was adjusted to 3 using HCl.

FIG. 20B shows data from an EQCM study of electrodeposition-stripping on a PDADMA/Cu-coated quartz crystal (PDADMA loading: 0.75 mg cm⁻²), where current is plotted as a function of time during the electrodeposition and stripping of cobalt and nickel; electrodeposition was carried out as described in reference to FIG. 20A.

FIG. 20C shows data from an EQCM study of electrodeposition-stripping on a PDADMA/Cu-coated quartz crystal (PDADMA loading: 0.75 mg cm⁻²), where change in mass is plotted as a function of time during the electrodeposition and stripping of cobalt and nickel; electrodeposition was carried out as described in reference to FIG. 20A.

FIG. 21A shows data from an EQCM study of electrodeposition-stripping on a PDADMA/Au-coated quartz crystal (PDADMA loading: 0.75 mg cm⁻²), where potential is plotted as a function of time during the electrodeposition and stripping of cobalt and nickel; electrodeposition was carried out at −0.725 V in a working fluid comprising 100 mM Co(II)+Ni(II) in 10 M LiCl and stripping was carried out at −0.08 V in a stripping solution comprising 5 mM NaNO₃, whose pH was adjusted to 3 using HCl.

FIG. 21B shows data from an EQCM study of electrodeposition-stripping on a PDADMA/Au-coated quartz crystal (PDADMA loading: 0.75 mg cm⁻²), where current is plotted as a function of time during the electrodeposition and stripping of cobalt and nickel; electrodeposition was carried out as described in reference to FIG. 21A.

FIG. 21C shows data from an EQCM study of electrodeposition-stripping on a PDADMA/Au-coated quartz crystal (PDADMA loading: 0.75 mg cm⁻²), where change in mass is plotted as a function of time during the electrodeposition and stripping of cobalt and nickel; electrodeposition was carried out as described in reference to FIG. 21A.

FIG. 22 shows a simplified schematic representation of an exemplary process envisioned in this disclosure for the electrochemical recovery of cobalt and nickel.

FIG. 23 shows composition (%) of liquid/solid hydrometallurgical streams: (i) spent NMC cathode, (ii) after selective cobalt electrodeposition followed by anodic stripping, (iii) final Co-rich electrodeposit after second cobalt selective electrodeposition, and (iv) final Ni-rich electrodeposit after selective nickel electrodeposition.

### DETAILED DESCRIPTION

Described herein is a synergistic combination of electrolyte control and electrochemical interface design to achieve molecular selectivity during electrodeposition of metals, such as cobalt and nickel, that have close reduction potentials. This new approach for selective electrodeposition may be particularly advantageous for separation and recovery of metals from waste batteries, mining waste, and other industrial waste sources.

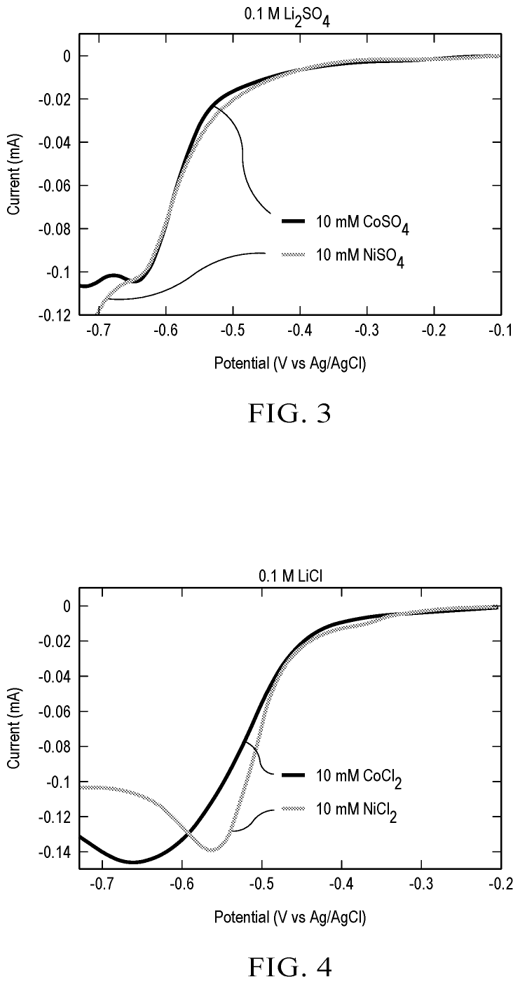

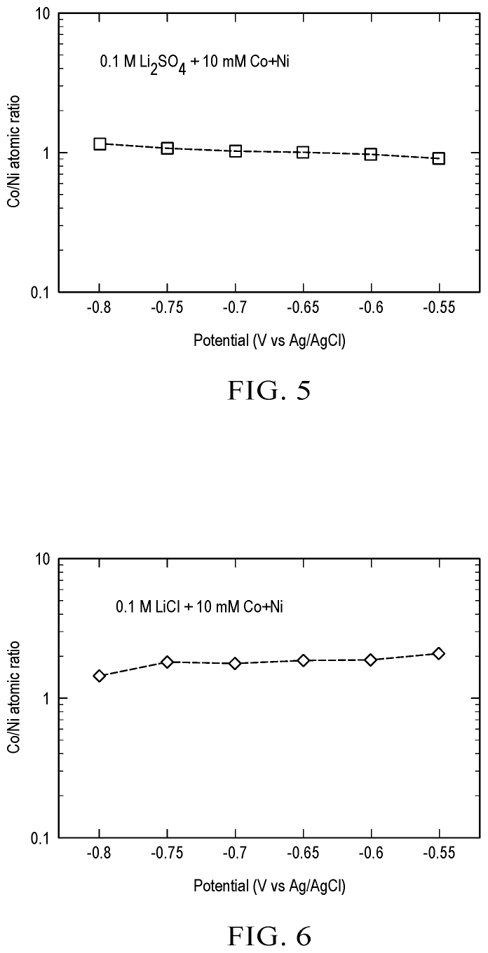

As indicated above, the close reduction potentials of cobalt and nickel present intrinsic difficulties for selective or preferential electrodeposition of one metal over the other. With traditional background electrolytes with low-to-moderate chloride (e.g., 0.1 M Li₂SO₄ and 0.1 M LiCl), cobalt and nickel exhibit similar patterns in linear sweep voltammetry (LSV) curves, and their onset (or reduction) potentials are not easily distinguishable, as shown in FIGS. 3 and 4, due to predominant cationic speciation of [Co(H₂O)₆]²⁺ and [Ni(H₂O)₆]²⁺. When chronoamperometric electrodeposition tests are carried out in a 1:1 mixture of 10 mM Co(II) and Ni(II) with 0.1 M Li₂SO₄ and 0.1 M LiCl, respectively, the surface Co/Ni ratios are in the range of 1˜2 throughout the entire potential range tested (−0.8 ˜−0.55 V), as shown in FIGS. 5 and 6, indicating difficulty in selectively depositing one specific metal while suppressing the other.

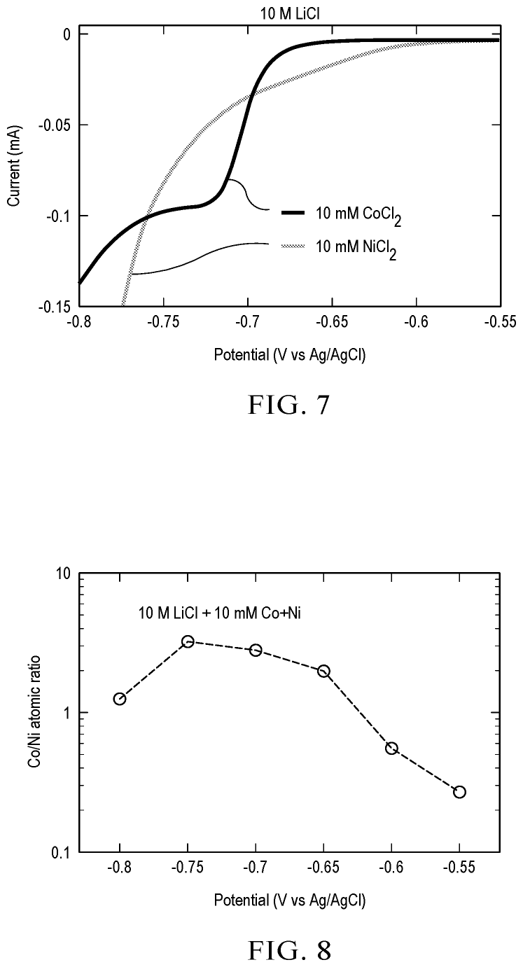

To solve this problem, the inventors have developed an effective electrolyte engineering approach to discriminate otherwise similar metals with alike aqueous properties. Incorporation of a concentrated salt (e.g., 10 M LiCl) is shown to allow for speciation or charge control by the formation of oppositely charged metal complexes, e.g., an anionic cobalt complex and a cationic nickel complex. In this situation, the LSV curves of cobalt and nickel show distinguishable differences in the onset or reduction potentials (−0.68 V and −0.59 V for cobalt and nickel, respectively), as shown in FIG. 7, indicating a feasible separation window where nickel can be selectively electrodeposited. In addition, anomalous deposition behavior at cathodic potentials more negative than the reduction potentials of both cobalt and nickel (where, surprisingly, cobalt is preferentially deposited), provide a mechanism for the selective deposition of cobalt, as discussed below in regard to FIG. 8.

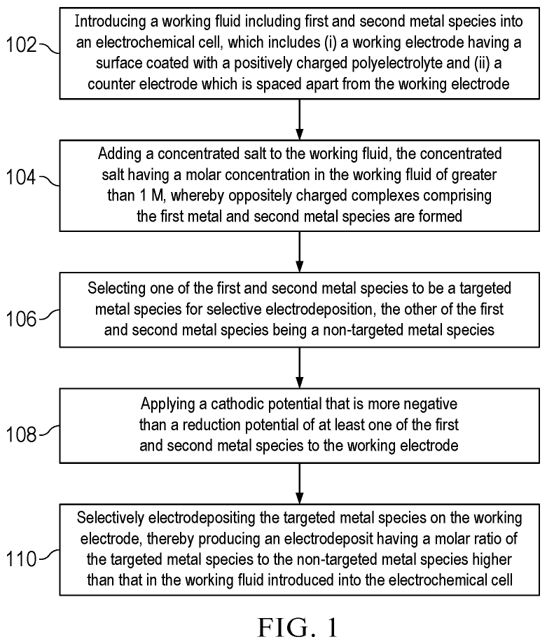

In addition to speciation control, interfacial tailoring of the working electrode with a positively-charged polyelectrolyte is shown to influence the atomic ratio of cobalt and nickel in the electrodeposit, depending on the polyelectrolyte loading level, enabling additional selectivity control for electrodeposition. This dual approach of electrolyte control and interfacial tailoring is demonstrated for metal recovery from practical lithium nickel manganese cobalt oxide (NMC) cathode materials, with final purities of about 96% and 94% being achieved for cobalt and nickel, respectively. Before these particular examples with cobalt and nickel are described in detail, this new method of selective deposition and metal recovery is described in reference to FIG. 1 for any metal species having close reduction potentials.

Referring to FIG. 1, the method of selective electrodeposition comprises introducing 102 a working fluid including first and second metal species into an electrochemical cell, which includes (i) a working electrode having a surface coated with a positively charged polyelectrolyte and (ii) a counter electrode which is spaced apart from the working electrode. The working fluid may be a waste fluid originating from industrial manufacturing, spent batteries, or mining operations, for example. Each of the first and second metal species in the working fluid may comprise a transition metal such as Ag, Au, Cd, Co, Cu, Cr, Fe, Hf, Hg, Ir, Lu, Mn, Mo, Nb, Ni, Os, Pd, Pt, Re, Rh, Ru, Sc, Ta, Tc, Ti, W, Y, Zn, or Zr. Typically, the first and second metal species comprise transition metal cations, such as cobalt cations, nickel cations, iron cations, manganese cations, etc. The reduction potentials of the first and second metal species may be similar or the same. For example, the reduction potential of the first metal species may be within about 2%, or within about 1%, of that of the second metal species. It is noted that the working fluid may include additional metal species beyond the first and second metal species having close reduction potentials.

Before or after the working fluid is introduced into the electrochemical cell, a concentrated salt is added 104 to the working fluid. The term “concentrated salt” refers to a salt having a molar concentration in the working fluid of greater than 1 M, and in some examples the molar concentration may be greater than 10 M, and/or as high as 15 M, or as high as 20 M. The concentrated salt may comprise or take the form of a halogenated salt (e.g., LiCl), an ionic liquid, and/or a deep eutectic solvent. The addition of the concentrated salt may lead to speciation, or a change in charge, such that oppositely charged complexes are formed in the working fluid from the first and second metal species. More specifically, an anionic complex comprising the first metal species and a cationic complex comprising the second metal species may be formed. In an example where the first metal species comprises cobalt cations, the anionic complex may be (CoCl₄²⁻), and in an example where the second metal species comprises nickel cations, the cationic complex may be [Ni(H₂O)₅Cl]⁺. The addition of the concentrated salt may be associated with a splitting of the reduction potentials of the first and second metal species, as evidenced by the LSV curves of cobalt and nickel referred to above and shown in FIG. 7. This splitting of the reduction potentials may provide a voltage window for selective electrodeposition of one of the metal species. For example, after addition of the concentrated salt, the reduction potentials of the first and second metal species may differ by at least about 10%, or at least about 12%.

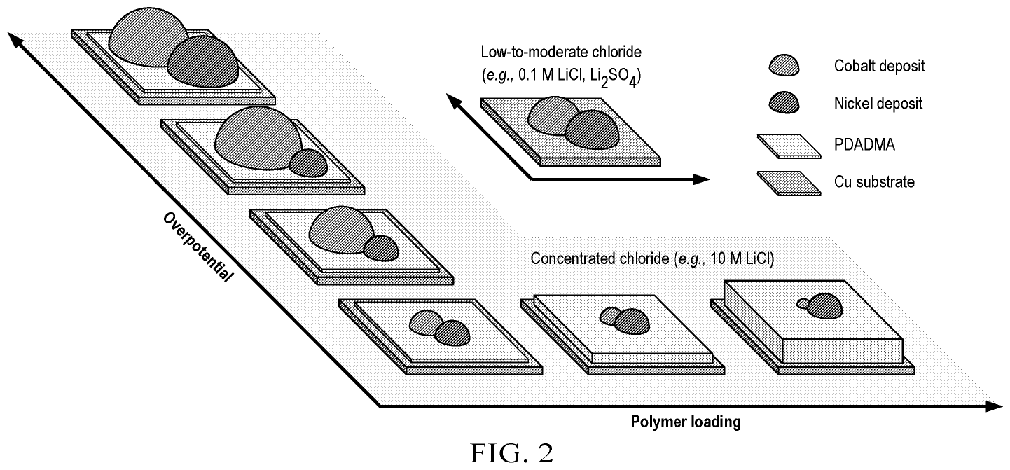

One of the first and second metal species is selected 106 as the targeted metal species for selective electrodeposition, while the other metal species is the non-targeted metal species. As illustrated in FIG. 2 for the particular example of cobalt and nickel, various aspects of the electrodeposition process, including the overpotential (or cathodic potential), the molar concentration of the concentrated salt, and/or the loading level of the polyelectrolyte on the surface of the working electrode, may influence which of the first and second metal species undergoes selective electrodeposition. Accordingly, the electrodeposition process is tunable.

Returning again to the flow chart of FIG. 1, a cathodic potential that is more negative than a reduction potential of at least one of the first and second metal species, and which may be between the reduction potentials of the first and second metal species, is applied 108 to the working electrode. In the case of nickel, which has a reduction potential of −0.59 V, and cobalt, which has a reduction potential of −0.68 V, the cathodic potential may be in the range of −0.60 V to −0.64 V, for example, which is more negative than the reduction potential of nickel and is also between the reduction potentials of nickel and cobalt. In some examples, the cathodic potential may be more negative than the reduction potentials of both the first and second metal species; surprisingly, selective or preferential deposition of one of the metal species may still occur over a selected range of cathodic potentials. For example, cobalt may be selectively deposited with a cathodic potential in the range from −0.65 V to about −0.8 V as evidenced by FIG. 8. This phenomenon may be referred to as anomalous deposition and is discussed further below.

During the application 108 of the cathodic potential, the targeted metal species, which is either the first or second metal species, is selectively or preferentially deposited 110 onto the working electrode, and an electrodeposit is formed. The electrodeposit has an atomic ratio of the targeted metal species to the non-targeted metal species that is increased compared to that in the working fluid introduced into the electrochemical cell. In other words, due to the selective or preferential electrodeposition, a molar or atomic ratio of the targeted metal species to the non-targeted metal species is higher in or at the surface of the electrodeposit than in the working fluid introduced into the electrochemical cell.

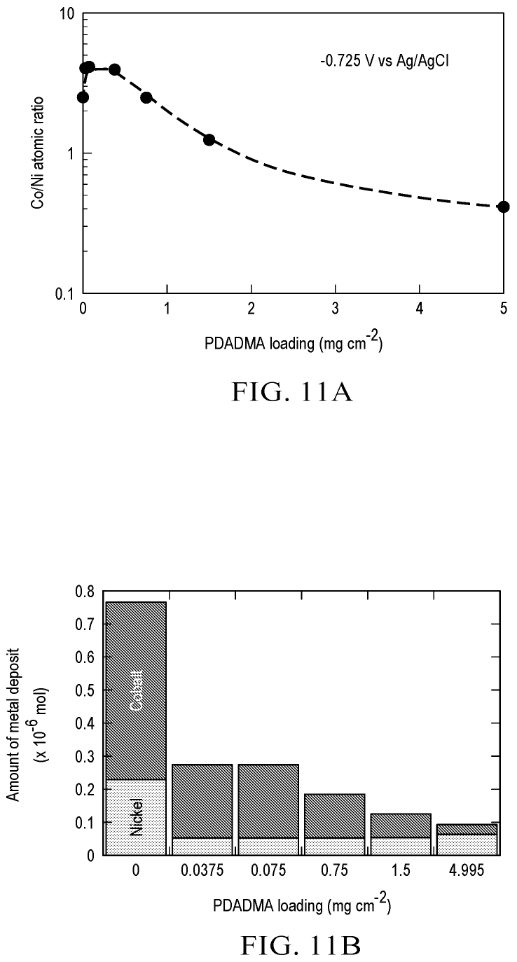

The inventors have recognized that the loading level of the positively charged polyelectrolyte coated on the surface of the working electrode may impact electrodeposition selectivity. For example, it has been found that improved binding of the anionic (negatively charged) complex can be achieved at lower loading levels, e.g., less than 1 mg cm⁻², or less than 0.075 mg cm⁻², such that the metal species associated with the anionic complex (e.g., Co) may be selectively or preferentially electrodeposited. In contrast, at higher loading levels, e.g., greater than 1 mg cm⁻², electrodeposition of the metal species associated with the anionic complex may be suppressed while the metal species associated with the cationic complex (e.g., Ni) may be selectively electrodeposited. This trend is observed with cobalt and nickel, as shown by the data in FIGS. 11A and 11B. Consequently, depending on which metal species is targeted for selective electrodeposition, the loading level of the positively charged polyelectrolyte may be selected to be relatively low, such as no greater than 0.2 mg cm⁻², or no greater than about 0.02 mg cm⁻², or relatively high, such as at least about 5 mg cm⁻², or at least about 10 mg cm⁻². Generally speaking, the polyelectrolyte may be coated on the surface at a loading level of greater than zero and up to about 100 mg cm⁻². The positively charged polyelectrolyte may comprise poly (diallyldimethyl ammonium) chloride (PDADMA), as in the examples in this disclosure, or poly(vinylbenzyltrimethylammonium chloride (PVBTMAC), poly (acryloyloxyethyltrimethylammonium) (PAOEt), poly(2-(dimethylamino) ethyl methacrylate) (PDMAEMA), poly (4-N-methylvinylpyridinium chloride) (PVMPB), or poly(allylamine hydrochloride (PAH).

The purity of the electrodeposit, that is, the percentage of the electrodeposit comprising the target metal species, may depend on the electrodeposition setup and conditions, such as the selected cathodic potential, the molar concentration of the concentrated salt in the working fluid, and/or the loading level of the polyelectrolyte on the surface of the working electrode. The atomic ratio of the first and second metal species in the working fluid may also influence the purity of the electrodeposit. For example, a working fluid having an atomic ratio of cobalt to nickel of 1:9 may lead to an electrodeposit having a higher nickel purity, after a single electrodeposition, than a working fluid having a 1:1 atomic ratio of cobalt to nickel. That being said, the selective electrodeposition method may be employed with working fluids including first and second metal species at any atomic ratio. For example, the atomic ratio of the first metal species to the second metal species in the working fluid introduced into the electrochemical cell may range from 1:100 to 100:1. Preferably, the purity of the electrodeposit is at least about 75%, at least about 90%, or at least about 95%, and the purity may be as high as 99% or 100%. To improve the purity of the electrodeposit, selective electrodeposition may be carried out more than one time, with stripping or regeneration of the working electrode taking place between electrodeposition cycles.

Thus, the method may further comprise, after the selective electrodeposition, conducting a stripping or regeneration process, whereby the first and second metal species are removed from the working electrode and captured in a stripping (or leaching) solution, which may comprise an acid, such as hydrochloric acid. In some examples, the stripping or regeneration process may be carried out solely by exposure of the electrodeposit to the stripping solution (e.g., when using a strong acid). In other examples, such as when using a weak acid, the stripping or regeneration process may further comprise, while the working and counter electrodes are in contact with the stripping solution, applying an anodic potential that is more positive than the reduction potentials of the first and second metal species to the working electrode, thereby facilitating removal of the first and metal species from the working electrode. Once the stripping or regeneration process has taken place and the first and second metal species have been captured or collected in the stripping solution, the stripping solution may be employed for a second electrodeposition process. Notably, the atomic ratio of the targeted metal species to the non-targeted metal species is higher in the stripping solution than in the working fluid originally introduced into the electrochemical cell.

After the stripping or regeneration process, the method may further comprise utilizing the stripping solution as the working fluid, and repeating the method of selective electrodeposition. That is, as described above, the stripping solution (which is now the working fluid) may be introduced into the electrochemical cell, the concentrated salt may be added to the working fluid, and the cathodic potential may be applied to the working electrode to selectively electrodeposit the targeted metal species. If desired or needed, the stripping or regeneration process followed by the selective electrodeposition may be carried out two or more times to achieve the desired purity of the final electrodeposit.

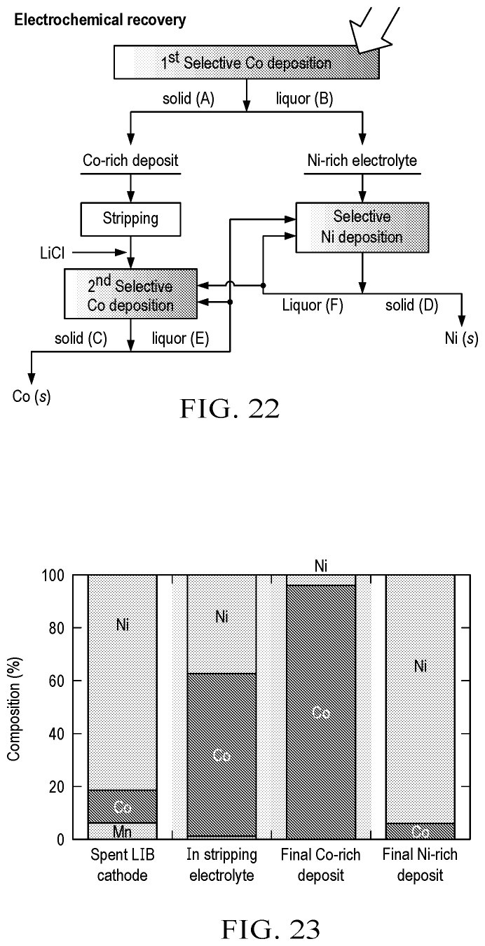

The above-described sequence of electrodeposition of a targeted metal species, followed by stripping or regeneration and then a second selective electrodeposition of the targeted metal species, is illustrated on the left-hand side of the flow chart of FIG. 22 for an example in which cobalt is the targeted metal species.

It is noted that, after the selective electrodeposition, the working fluid is a depleted working fluid having a reduced amount of the targeted metal species compared to the working fluid introduced into the electrochemical cell. The depleted working fluid also has a higher atomic ratio of the non-targeted metal species to the targeted metal species, again, in comparison with the working fluid originally introduced into the electrochemical cell. For this reason, the depleted working fluid may be well suited for selective electrodeposition of the (originally) non-targeted metal species. Accordingly, the method may further comprise introducing the depleted working fluid into a second electrochemical cell for selective electrodeposition of the non-targeted metal species, where the second electrochemical cell includes (i) a second working electrode having a surface coated with a positively charged polyelectrolyte and (ii) a second counter electrode spaced apart from the second working electrode. Because the depleted working fluid already contains a concentrated salt from the first electrodeposition of the targeted metal species, it may not be necessary to add additional salt to the depleted working fluid. To initiate selective electrodeposition, a cathodic potential that is more negative than a reduction potential of the (originally) non-targeted metal species is applied to the second working electrode, and the non-targeted metal species is selectively electrodeposited on the second working electrode. Accordingly, a second electrodeposit is formed, where the second electrodeposit has an atomic ratio of the non-targeted metal species to the targeted metal species that is higher than that of the depleted working fluid introduced into the second electrochemical cell. This is illustrated on the right-hand side of the flow chart of FIG. 22 for an example in which nickel is the originally non-targeted metal species.

The selective electrodeposition process may be either a batch process or a continuous process. In the former case, a discrete volume of the working fluid may be introduced into the electrochemical cell; in the latter case, a continuous stream of the working fluid may be introduced into and flowed through the electrochemical cell. If a continuous stream of the working fluid is provided for selective electrodeposition and recovery, then the concentrated salt added to the working fluid may also be added continuously to ensure the desired molar concentration. However, after stripping (or leaching), the working fluid may already include concentrated salt assuming a concentrated acid is used in the stripping or regeneration process. The above described electrodeposition and stripping or regeneration processes may be carried out without heating, that is, at ambient or room temperature (e.g., 20-25° C.).

In an example in which the working fluid is a waste fluid derived from battery manufacturing, the method may further comprise preparing the working fluid from a spent battery (or a number of spent batteries) prior to introducing the working fluid into the electrochemical cell. The preparation may entail discharging the spent battery, and dismantling the spent battery to obtain a current collector including a cathode active material. A solvent may be employed to release the cathode active material from the current collector. For example, N-methylpyrrolidine (NMP) or another suitable solvent may be used to dissolve the polymeric (e.g., polyvinylidene fluoride (PVDF)) binder securing the cathode active material to the current collector. The cathode active material may then be leached with an acid. After leaching, the pH of the working fluid may be adjusted to about 3, e.g., using lithium hydroxide. The working fluid including the first and second metal species, which may be cobalt and nickel from a spent NMC battery, is thus formed.

A system for selective electrodeposition for metal recycling is also described in this disclosure. The system includes an electrochemical cell comprising: a working electrode having a surface coated with a positively charged polyelectrolyte; a counter electrode spaced apart from the working electrode; and a power supply configured for electrical connection to the working and counter electrodes. The positively charged polyelectrolyte may be coated on the surface at a loading level of greater than zero and up to about 100 mg cm⁻². In some examples, the loading level may be no greater than 0.2 mg cm⁻², or no greater than about 0.02 mg cm⁻²; in other examples, the loading level may be at least about 5 mg cm⁻², or at least about 10 mg cm⁻². The positively charged polyelectrolyte may comprise PDADMA, as in the examples in this disclosure, or poly(vinylbenzyltrimethylammonium chloride (PVBTMAC), poly (acryloyloxyethyltrimethylammonium) (PAOEt), poly(2-(dimethylamino) ethyl methacrylate) (PDMAEMA), poly(4-N-methylvinylpyridinium chloride) (PVMPB), or poly(allylamine hydrochloride (PAH). If the system is intended for batch use, the electrochemical cell may be configured to contain or hold a working fluid; if the system is intended for continuous use, the electrochemical cell may be configured for flow of a working fluid through the cell, and the system may further include a pump to control the flow. The working electrode and the counter electrode may comprise carbon or a metal such as copper, titanium or iron. For example, carbon paper or a metal foil (e.g., copper foil) may be suitable.

### Speciation Control of Cobalt and Nickel

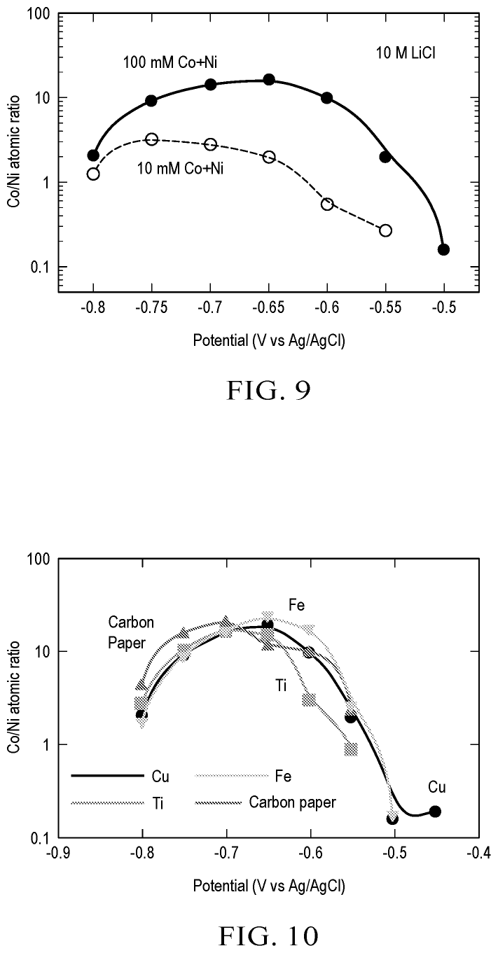

In the examples described in this disclosure, a concentrated chloride (10 M LiCl as a model electrolyte) is used as a background electrolyte for speciation control, which helps the formation of the stable anionic tetrachloro complex (CoCl₄²⁻). In this electrolyte, nickel exists as the cation [Ni(H₂O)₅Cl]⁺, so opposite charges can be imparted. The LSV curves of cobalt and nickel show a distinguishable difference in the onset potentials (−0.68 V and −0.59 V for cobalt and nickel, respectively) as discussed above in reference to FIG. 7, indicating a feasible separation window where nickel can be selectively electrodeposited. The negative shift in the cobalt electrodeposition can be attributed to the complex formation effect. The corresponding deposit composition analysis reveals that the moderate applied potentials (−0.60˜−0.55 V) promoted the formation of deposits with higher nickel composition, as evidenced in FIG. 8. Referring again to FIG. 7, during the cathodic LSV sweep toward more negative range (<−0.69 V), cobalt showed steeper current increase followed by a shoulder (−0.72 V), while nickel's current magnitude grew slowly near its onset potential and then exhibited gradual enhancement in more negative range (<−0.75 V). The slower growth in the current of nickel electrodeposition can be ascribed to the sluggish dehydration of [Ni(H₂O)₅Cl]⁺ complex. Interestingly, the compositions at the relatively negative region (<−0.65 V) revealed the formation of cobalt-selective electrodeposits, which, at −0.75 V, showed the highest Co/Ni ratio of 3.18 (see FIG. 8). Applying a more negative potential (<−0.8 V) resulted in Co/Ni ratio close to 1, implying a similar degree of co-deposition of the two metals. The cobalt-selective electrodeposition in the potential range of −0.65˜−0.8 V can be ascribed to an effect of so-called anomalous deposition, in which less noble cobalt is more preferentially deposited compared to the more noble nickel. In this study, the degree of the anomalous deposition in terms of Co/Ni ratio was the highest in 10 M LiCl (at −0.75 V), compared to 0.1 M LiCl and 0.1 M Li₂SO₄, as can be seen from FIGS. 5, 6 and 8. When the initial concentrations of both metals were increased to 100 mM, the Co/Ni ratio greatly increased even more, reaching values up to 14, as shown in FIG. 9. The enhancement in cobalt selectivity with the increase in bulk concentrations is in agreement with the fact that cobalt deposition may be mass transfer-controlled during anomalous electrodeposition. On the other hand, the increase in the nickel content (the decrease in cobalt content) at highly negative potential (e.g., at −0.8 V) suggests that nickel deposition may be activation-controlled. Similar behavior was observed using other electrode materials, as indicated in FIG. 10.

### Electrogravimetric Analysis of Cobalt/Nickel Anomalous Deposition

To obtain insights into the electrochemical reaction during the electrodeposition, electrochemical quartz crystal microbalance (EQCM) analysis was carried out. By combining the change in mass with Faraday's law, the specific mass change per the number of electrons could be determined—namely m/z (g mol⁻¹)—which which is a useful parameter for identifying faradaic redox processes and efficiencies. For example, the direct cobalt reduction takes place according to this reaction:

Co(II)+2e⁻→Co(s) (1)

where the corresponding theoretical m/z value is 29.5 g mol⁻¹ (atomic weight of cobalt/2e−=58.9 g mol⁻¹/2e⁻). If there happens a parallel side reaction of hydrogen evolution, cobalt electrodeposition can also occur through the formation of cobalt hydroxide:

2H₂O+2e⁻→H₂+2OH⁻ (2)

Co(II)+2OH−→Co(OH)₂(s) (3)
where the corresponding theoretical m/z value is 46.5 g mol⁻¹ (molecular weight of cobalt hydroxide/2e⁻=92.9 g mol⁻¹/2e⁻). In the same way, the theoretical m/z value for direct nickel reduction (29.3 g mol⁻¹) and nickel hydroxide formation (46.4 g mol⁻¹) could be determined.

First, at moderate overpotentials, such as −0.625 and −0.725 V for 10 mM Ni(II) and Co(II), respectively, the electrode mass kept increasing due to electrodeposition. It was observed that m/z was about only 10 g mol⁻¹ in Ni(II) bath, which is in accordance with relatively low faradaic efficiency of nickel deposition. On the other hand, in 10 mM Co(II) in 10 M LiCl, a higher faradaic efficiency (>90%) was observed near the onset potentials of cobalt deposition. The m/z value increased to 51.2±0.3 g mol⁻¹ in the first 1 min, which is compatible with Co(OH)₂ formation according to Equation (2) and (3), followed by gradual decrease in m/z ratio, indicating that Co(OH)₂ is formed at the early stage of the electrodeposition because of local pH increase (Equation (2) and (3)). The subsequent decrease in m/z ratio can be ascribed to: (1) cobalt deposition via a direct pathway (m/z=29.5 g mol⁻¹ Equation (1)) and (2) hydrogen evolution on electrodeposited catalytic cobalt sites, as reported earlier. The formation of Co(OH)₂ was also observed at a higher overpotential of −0.8 V in 10 mM Co(II), while Ni(II) still exhibited similar m/z value (˜10 g mol⁻¹). The process of Co(OH)₂ generation also involves the formation of cobalt monohydroxide as an intermediate:

Co(II)+OH⁻→CoOH⁺ (4)

CoOH⁺→CoOH⁺_{ads} (5)

CoOH⁺/CoOH₂ have higher adsorption ability compared to NiOH⁺/NiOH₂, and thus play a critical role in inhibiting nickel deposition and lead to the anomalous behavior with highly prioritized cobalt deposition. The unique transition from normal to anomalous electrodeposition in concentrated chloride offers a new venue of potential-dependent selectivity tuning. Furthermore, concentrated chloride displayed an additional benefit of more efficient suppression of hydrogen evolution due to decreased water activity, leading to higher faradaic efficiency compared to low-to-moderate chloride electrolyte.

### The Effect of PDADMA on Tuning Electrodeposition Selectivity

Functional polymer-coated interfaces were prepared and coupled with electrolyte-based strategy. Inspired from opposite charges of cobalt and nickel and the pronounced molecular interaction between CoCl₄²⁻ and quaternary amine, a positively-charged polyelectrolyte, poly(diallyldimethylammonium chloride) (PDADMA, Mw 200,000˜350,000) was loaded on the surface of a pristine copper foil, and its effect on selectivity was investigated. PDADMA loaded on a pristine copper foil in general exhibited smooth and uniform coating, except for unevenly distributed cracks developed with a relatively high PDADMA loading (e.g., 0.75 mg cm⁻²). As shown in FIG. 11A, relatively small loading (≤0.075 mg cm⁻²) exhibited improvement in the surface Co/Ni ratio compared to a pristine Cu substrate. In FIG. 11B, any PDADMA-loaded surface (PDADMA/Cu) moderated total amount of metal deposited compared to pristine Cu because of increased surface resistance. When pristine Cu (0 mg cm⁻²) was compared with a small loading of PDADMA/Cu (0.0375 mg cm⁻²), the degree of PDADMA-driven deposition suppression was larger for nickel as compared to cobalt, because positively charged PDADMA helps binding of negatively charged CoCl₄²⁻. Interestingly, as PDADMA loading further increased, the amount of cobalt on electrodeposits kept decreasing, while nickel contents were maintained, as shown in FIG. 11B, leading to the shift to nickel-selective electrodeposition; at the potential of −0.725 V, Co/Ni ratio was 2.3 for pristine Cu, but it decreased to 0.40 for the electrode with PDADMA loading of ˜5 mg cm⁻² (4.995 mg cm⁻²) as shown in FIG. 11A.

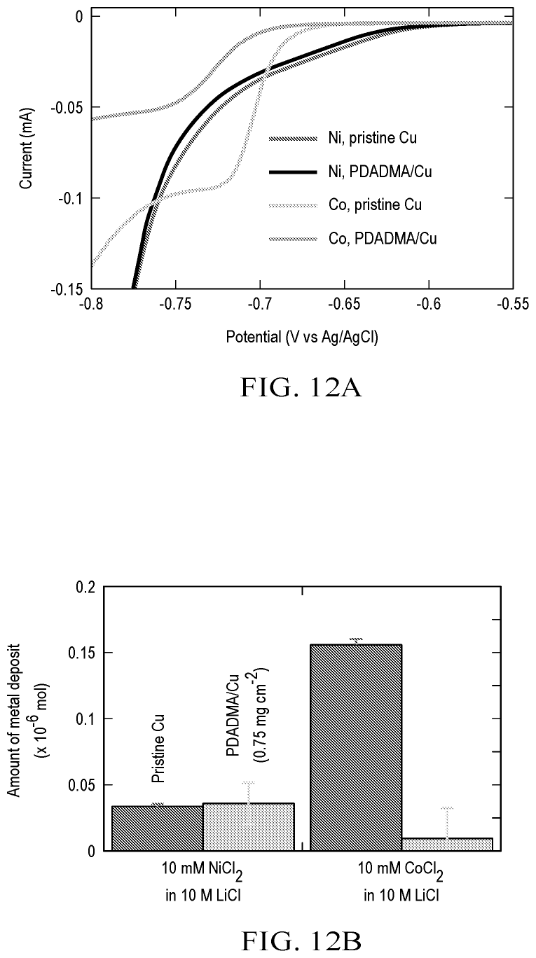

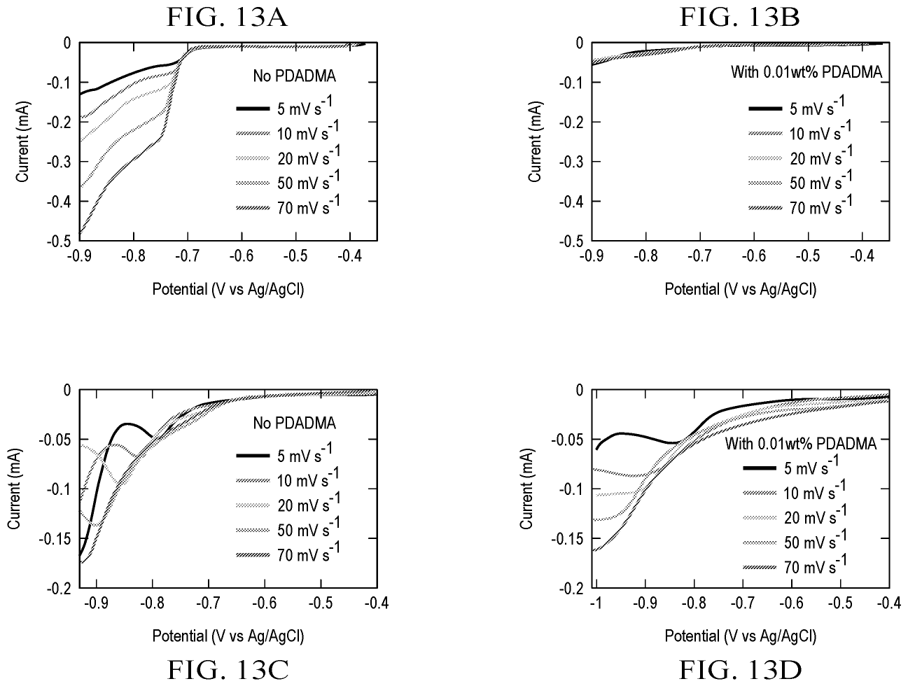

To elucidate the underlying mechanism of selectivity tuning, a single metal salt of 10 mM Ni(II) or Co(II) was tested with LSV using pristine copper or PDADMA/Cu (0.75 mg cm⁻²) (see FIG. 12A). In the case of 10 mM Ni(II) in 10 M LiCl, the LSV signal was not largely affected by the presence of PDADMA on the substrate, exhibiting almost similar onset potential (ΔEₒₙₛₑₜ=0.004 V) to pristine copper. In the case of 10 mM Co(II), however, PDADMA/Cu exhibited a seriously decreased LSV signal with reduced current and discernable negative shift in the onset potential (ΔEₒₙₛₑₜ=0.02 V), indicating suppressed cobalt electrodeposition and splitting between the reduction potential of cobalt and nickel. When chronoamperometric electrodeposition was carried out at −0.725 V in single metal salt solution consisting of 10 mM Ni(II) or 10 mM Co(II) in 10 M LiCl, the amount of electrodeposited nickel was similar between pristine Cu and PDADMA/Cu, while cobalt electrodeposition on PDADMA/Cu accounted only for 7% of pristine Cu (see FIG. 12B). The inhibiting role of PDADMA in cobalt electrodeposition is ascribed to the limited mobility of CoCl₄²⁻ localized in excess layer of positively-charged PDADMA. To prove this, further LSV analysis was carried out in single metal salt of either 10 mM Ni(II) or 10 mM Co(II) in 10 M LiCl at various scan rates, with or without 0.01 wt % of PDADMA added as a homogenous additive into the liquid phase. Without PDADMA, 10 mM Co(II) displayed a linear relation between the peak current and the square root of scan rate, suggesting Co(II) reduction is diffusion-controlled, as shown in FIG. 13A. Surprisingly, adding 0.01 wt % PDADMA significantly repressed the current (see FIG. 13B). The calculation of the diffusion coefficient of CoCl₄²⁻ mixed with 0.01 wt % PDADMA showed a dramatic decrease (4.19×10⁻¹⁰cm² s⁻¹) compared to CoCl₄²⁻ in bulk electrolyte without the polyelectrolyte (2.50×10⁻⁸cm² s⁻¹), indicating decreased mobility of CoCl₄²⁻ due to the stabilization effect by PDADMA.

On the other hand, the diffusion coefficient of 10 mM Ni(II) was 1.56×10⁻⁸cm² s⁻¹ and 1.43×10⁻⁸ cm² s⁻¹ without and with the addition of 0.01 wt. % PDADMA, respectively, suggesting Ni(II) in 10 M LiCl is not much affected by the presence of PDADMA, in contrast to Co(II) (see FIGS. 13C and 13D). The diffusion coefficient was calculated using the linear sweep voltammograms obtained in FIGS. 13A-13D. The following equation for soluble-insoluble redox pairs was employed:

$${i}_{p} = 1.082 nFAC \sqrt{\frac{nFDv}{RT π}} ,$$

where iₚ is the peak current (A), n is the number of electrons transferred, C is the concentration of metal (mol cm⁻³), A is the electrode area (cm²), F is Faraday constant (96485 C mol⁻¹), u is the scan rate (V s⁻¹), and D is the diffusion coefficient (cm² s⁻¹). Note that the current magnitude in linear sweep voltammetry contains partial contribution from metal deposition and also from hydrogen evolution. Therefore, the true partial contribution of metal deposition during LSV was corrected by using Faradaic efficiency during the sweep processes.

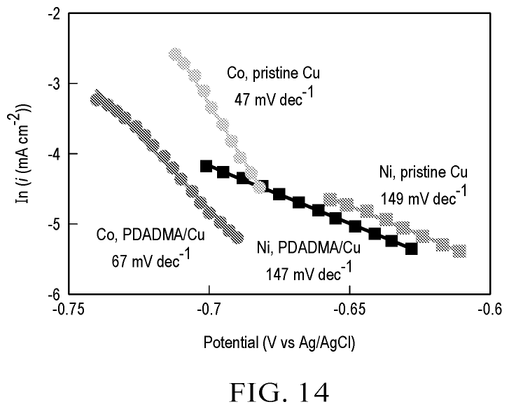

The distinct sensitivity of cobalt and nickel to PDADMA is also reflected in the Tafel plot of FIG. 14; PDADMA coating brought about increase in the Tafel slope in 10 mM Co(II) (from 47 to 67 mV dec⁻¹), but only a small change was observed in 10 mM Ni(II) (from 149 mV dec⁻¹ for pristine Cu to 147 mV dec⁻¹ for PDADMA/Cu). Note that the current magnitude in voltammetry contains a partial contribution from metal deposition and also from hydrogen evolution, which are indistinguishable. Therefore, the true partial contribution of metal deposition during the Tafel analysis was corrected by using average Faradaic efficiency values in near onset potential range (−0.7 to −0.6 V for Ni(II) and −0.8 V to −0.7 V for Co(II)). These results suggest how the discrimination in molecular interactions can affect selectivity in electrodeposition processes.

Synergistic Electrolyte and Interfacial Control for Optimized Electrodeposition Selectivity

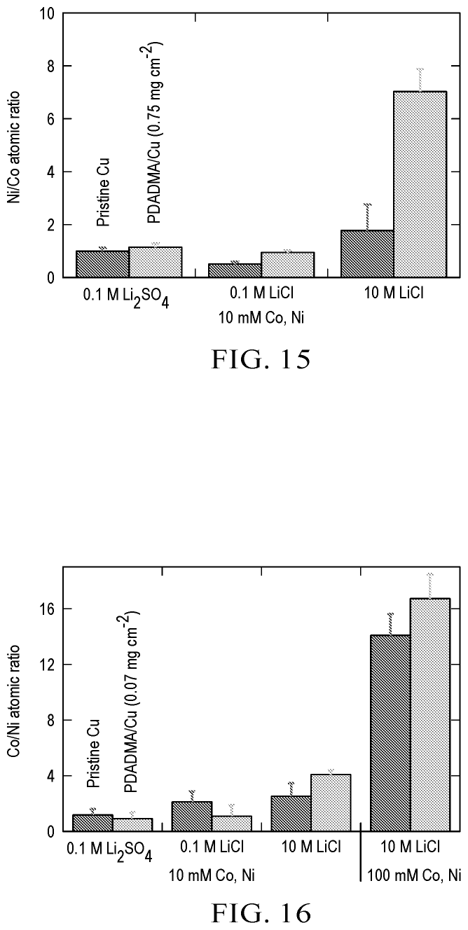

As shown above, the modulation of surface charge allows for selectivity tuning—enhancing the cobalt selectivity with a low polymer loading and the suppression of cobalt deposition with excess polymer loading (or a thicker polymer layer). At —0.6 V, a nickel-rich deposit featuring a Ni/Co ratio of 1.81 was formed with pristine copper in concentrated chloride, and it increased to 7.05 by employing PDADMA/Cu with the polymer loading of 0.75 mg cm², as shown in FIG. 15A. Similarly, at a cobalt-favorable potential of −0.725 V, concentrated chloride showed already superior cobalt selectivity without PDADMA (Co/Ni: 14.08 at 100 mM Co(II)+Ni(II)) thanks to the anomalous behavior, and the thin PDADMA layer (0.07 mg cm⁻²) brought about further enhancement, reaching the highest Co/Ni ratio of 16.73, as shown in FIG. 16. For both cobalt (−0.725 V) and nickel (−0.6 V), polymer-driven selectivity enhancement was observed only in concentrated chloride thanks to the speciation control, while other electrolytes with low-to-moderate chloride did not display significant PDADMA-driven improvements, as can be observed in FIGS. 15 and 16. In low-to-moderate chloride, both Co(II) and Ni(II) mainly exist as a cationic complex, and therefore, the positive polyelectrolyte PDADMA has no charge-specific stabilization. These results show the benefits of both speciation control through electrolyte selection and interface tuning by surface functionalization.

Solid-phase surface characterizations based on spectroscopy agreed with FIGS. 15 and 16: the high Co/Ni ratio was confirmed by X-ray fluorescence (XRF) analysis (Co/Ni: 16.0) and energy-dispersive spectroscopy (EDS) mapping (Co/Ni: 18.4), which all displayed larger Co/Ni ratios on PDADMA/Cu compared to pristine Cu. X-ray photoelectron spectroscopy (XPS) analysis also confirmed PDADMA-driven selectivity improvements: for both nickel-rich deposit at-0.6 V (Ni/Co: 1.45 and 3.01 for pristine Cu and PDADMA/Cu (0.75 mg cm⁻²), respectively) and cobalt-rich deposit at −0.725 V (Co/Ni: 10.19 and 12.41 for pristine Cu and PDADMA/Cu (0.07 mg cm⁻²), respectively). In addition, the peak fitting of XPS analysis exhibited several peaks at the binding energy of: ˜778.3 eV (metallic Co), ˜780.5 eV (CoOOH), and ˜782.0 eV (Co(OH)₂) in Co 2p3/2 spectrum and ˜852.5 eV (metallic Ni), ˜855.6 eV (Ni(OH)₂), and ˜856.5 eV (Ni₂O₃) in Ni 2p3/2 spectrum. These peaks indicate the formation of oxide/hydroxides, including metallic species, partially due to surface oxidation and hydroxide formation during electrodeposition, which is in agreement with EQCM analysis (Equation (2) and (3)). The final product speciation of oxides/hydroxides are value-added, recyclable precursors for the fabrication of cathode materials. In addition, the morphology of anomalously electrodeposited cobalt and nickel in the presence of PDADMA differed from the deposit formed in the absence of PDADMA. The deposit without PDADMA exhibited the formation of needle-like dendrites. The formation of dendrites can be ascribed to a locally-enhanced electric field. In contrast, PDADMA/Cu (0.07 g cm⁻²) exhibited rough and grainy deposits, and thicker PDADMA/Cu (0.75 mg cm⁻²) showed a wrinkled morphology without sharp dendrites. The SEM analysis reveals that PDADMA tunes not only cobalt to nickel selectivity, but also affects the morphology of the electrodeposit, which can be ascribed to the surface conduction of CoCl₄²⁻ in the positively charged PDADMA layer.

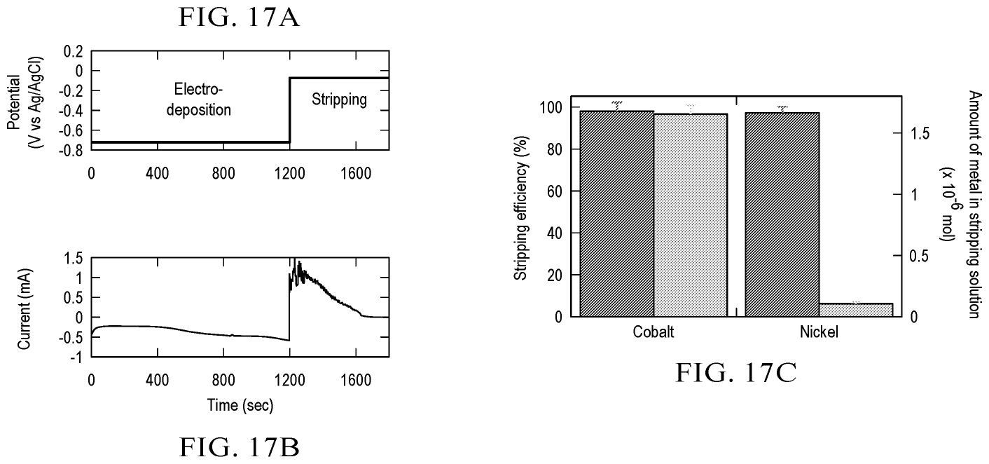

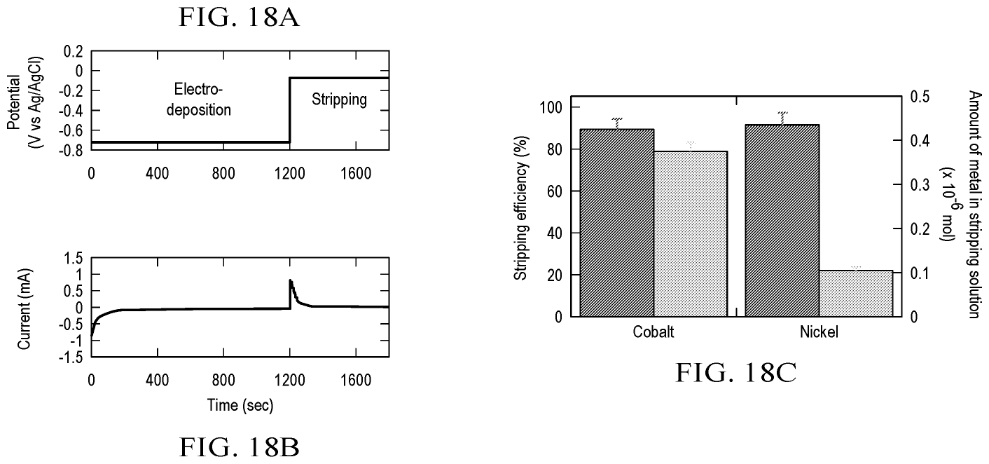

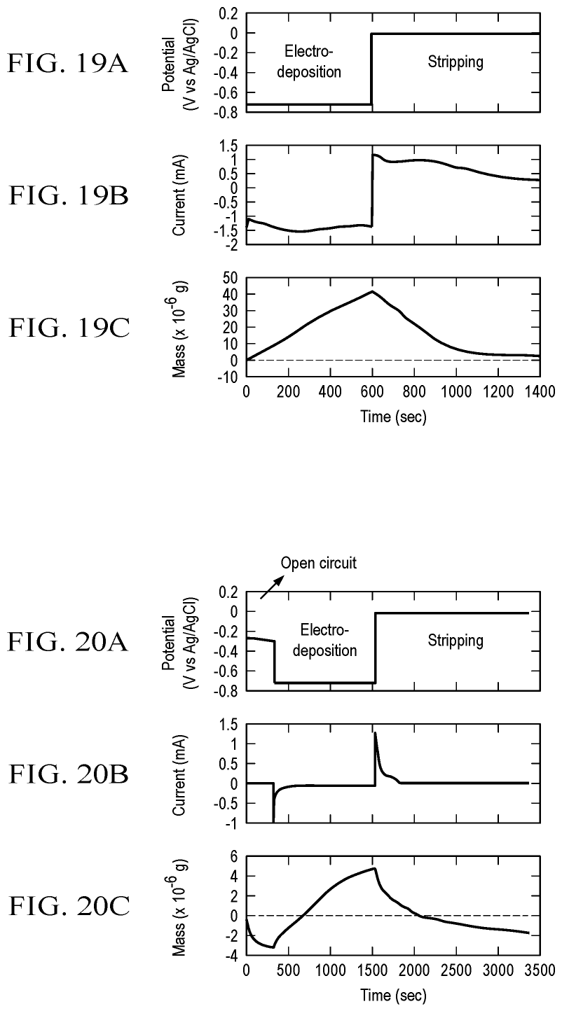

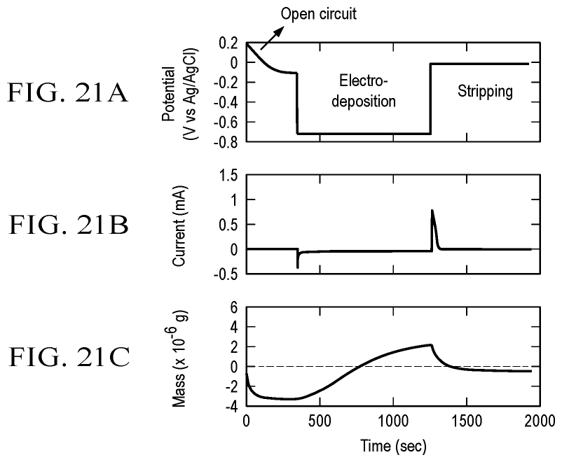

Also, the reversible nature of electrodeposition and stripping of cobalt and nickel was demonstrated by first electrodepositing in 100 mM Co(II)+Ni(II) in 10 M LiCl at −0.725 V and then by applying −0.08 V for releasing (stripping) electrodeposited cobalt and nickel into 5 mM NaNO₃, whose pH was adjusted to 2.9˜3.0, as shown in FIGS. 17A and 18A. A current-time (/vs t) plot during stripping revealed a gradual decrease in the magnitude of the electrochemical current, which can be associated with the rapid dissolution of electrodeposited cobalt/nickel (see FIGS. 17B and 18B). As depicted in FIGS. 17C and 18C, PDADMA/Cu electrodes exhibited high stripping efficiencies (>90%, defined as the ratio of cobalt/nickel stripped to electrodeposited) for both metals, with the same trend of selectivity tuning observed. EQCM analysis was employed, allowing the direct tracking of the change in the mass on the quartz crystal in real-time during the electrodeposition/stripping. First, when using a Cu-coated quartz crystal, applying −0.725 V revealed the increase in the mass (70 ng sec⁻¹), as displayed in FIG. 19C, which was ascribed to the cobalt/nickel electrodeposition. It was observed that the deposited cobalt/nickel was released into 5 mM NaNO₃ (pH=2.9˜3.0) by applying −0.08 V; about 96% of the mass increase caused by electrodeposition was recovered during the stripping phase (see FIG. 19C), indicating high reversibility of electrodeposition/stripping. Also, the similar EQCM analysis was tested during electrodeposition/stripping using PDADMA/Cu and PDADMA/Au-coated quartz crystal to confirm the stability of PDADMA. An initial drop in the mass of the electrode was observed during open-circuit pre-equilibrium stage (see FIGS. 20C and 21C), which was attributed to the dissolution of PDADMA in the deposition electrolyte; however, the dissolution of polymer did not continue and there appeared a plateau in the mass. During the electrodeposition, there was a discernable increase in mass (average rate: 6.8 ng sec⁻¹ for PDADMA/Cu and 5.9 ng sec⁻¹ for PDADMA/Au); here, the obtained mass exceeded the theoretical maximum mass increase calculated with the assumption of 100% faradaic efficiency, indicating the re-adsorption of the positively charged PDADMA onto the cathodic substrate. Also, the chronoamperometric stripping revealed a current peak in the current-time curve (see FIGS. 20B and 21B), which can be associated to the simultaneous stripping of cobalt/nickel, as reflected in the decrease in the mass during the corresponding time interval of the peak (FIGS. 20C and 21C). The change in the mass approached to zero immediately after the anodic current diminished to zero. There was a slight continuous decrease in the mass on the quartz crystal (average rate: −1.33 ng sec⁻¹ for PDADMA/Cu and −0.72 ng sec⁻¹ for PDADMA/Au) even after stripping was over (that is, after the current became stabilized) due to the electrostatic repulsion between the substrate and positively charged PDADMA. Even so, this loss can be effectively prevented by stopping the chronoamperometric operation once the stripping current approaches to zero. In these experiments, the loss in the mass of PDADMA upon prolonged anodic stripping (1 h) accounted for only <0.3% of the entire PDADMA loading (0.75 mg cm⁻²), demonstrating the stability of the polyelectrolyte upon electrodeposition/stripping. Thus, these results point to an innovative way of recovering electrodeposited cobalt/nickel without intensive use of harmful chemicals in practical applications.

### Recovery of Cobalt and Nickel From Spent NMC Cathodes

These findings provide fundamental insights on how synergistic electrolyte and surface charge control can tune selectivity during electrodeposition of two metals with similar reduction potentials. Beyond fundamental studies in interfacial electrochemistry, this concept may be applicable to the selective recovery of cobalt and nickel from spent LIBs, providing a sustainable pathway for battery recycling.

To provide a preliminary proof of feasibility, 18650 NMC batteries were pretreated in the order of discharging, dismantling, NMP treatment, and leaching (see the Methods section for details), to separate cathode active materials from the LIBs-more precisely, from the aluminum current collector and PVDF binder-in a safe and efficient manner. In the experiments, 4 g of harvested cathode powder (obtained after NMP treatment/filtration/drying) was leached in 30 mL of 10 M HCl, and pH was adjusted to 3.0 using LiOH; this procedure resulted in the formation of the working fluid, which was a dark green mixture of nickel-rich concentrated chloride, composed of cobalt (5,695 mg L⁻¹), nickel (37,150 mg L⁻¹), and manganese (2,820 mg L⁻¹)-the atomic ratio of Co: Ni: Mn was 1.00:6.52:0.50.

Here, the feasibility of the designed electrochemical recovery process for battery recycling was demonstrated by utilizing the working fluid obtained as described above. First, a cycle of electrodeposition/stripping was carried out: first electrodeposition at −0.725 V on a PDADMA/Cu (0.07 mg cm⁻²) electrode allowed for selective up-concentration of cobalt on an electrodeposit (stream “A” in FIG. 22), and anodic stripping provided a simple way of releasing recovered solid-phase cobalt/nickel into a liquid phase for secondary up-concentration/processing. ICP-OES analysis revealed that the atomic ratio of Co: Ni: Mn in the stripping electrolyte changed to 1.00:0.60:0.02 (see FIG. 23). Also, the stripping electrolyte, after the addition of 10 M LiCl, exhibited the distinctively bluish color, which is originated from the formation of predominant CoCl₄²⁻ complex, as compared to the strong greenish and nickel-rich electrolyte obtained right after the leaching, again confirming the up-concentration of cobalt over nickel by electrodeposition/stripping. The secondary PDADMA-driven electrodeposition at −0.725 V in the up-concentrated electrolyte brought about significantly improved cobalt purity (stream “C”), reaching 96.4+3.1% (see FIG. 23).

Also, the first selective cobalt deposition brought about an increase in Ni/Co ratio in a remaining liquid-phase (stream “B” in FIG. 22); the atomic ratio of Co: Ni: Mn in the liquor was 1.00:9.05:0.73, and this is an advantageous condition for subsequent selective nickel recovery. At −0.6 V, nickel purity of 94.1+2.3% on the deposit (stream “D”) was obtained (FIG. 23). The remaining liquid electrolytes after the secondary cobalt electrodeposition (stream “E”) can be repeatedly treated for multiple cycles until desired cobalt purity/recovery rate are obtained. If the Co/Ni ratio in the stream “E” becomes reversed (e.g., Co/Ni<1), which is not a desirable condition for the recovery of high-purity cobalt, the stream can be sent for selective nickel recovery to control nickel concentration. In the similar way, the selective nickel deposition can be conducted for multiple cycles from the stream “F”, and as the level of nickel decreases and thus Co/Ni becomes too high, which is disadvantageous for high-purity nickel recovery, the stream can be sent for selective cobalt deposition. The two selective deposition process can work in a complementary manner to control Co/Ni ratio to be in an appropriate level. Also, during the selective recovery of cobalt/nickel assisted by PDADMA, there was negligible manganese co-deposition due to the large potential window.

In summary, a fully electrochemical method of selective recovery of metals such as cobalt and nickel from primary or secondary waste sources, such as spent lithium-ion batteries, has been described. This electrochemical method allows for selective electrochemical deposition of metals with similar reduction potentials. Control of speciation of constituent metals enables to discriminate otherwise similar metals with alike aqueous properties. Along with the solution-based approach, interfacial tailoring of the electrode with a charged polyelectrolyte allows for additional selectivity control. The two approaches synergistically help electrolyte-and polyelectrolyte-driven splitting of reduction potentials, thereby enabling to achieve high selectivity in multicomponent electrodeposition. This concept can be generalized to other critical element recovery processes, by combining electrolyte-and interface-based control to expand to broader metal valorization.

### Methods

### Example 1: Electrodeposition of Cobalt and Nickel

All the electrochemical deposition experiments were conducted in a BASi electrochemical cell with a three-electrode configuration. Copper foil was employed as a working electrode for cobalt and nickel deposition; the electrodes were prepared by cutting copper foil (thickness 0.25 mm, 99.98% trace metals basis, Sigma-Aldrich) into a dimension of 1 cm×2 cm. Copper foil was thoroughly washed with ethanol and acetone before use. Then, the back side of the foil was pasted on electrical tape. For the preparation of PDADMA-coated copper foil, 0.75 L of PDADMA solutions with different concentrations (0.1, 0.5, 1, 5, 10, 20 mg PDADMA in 1 mL of ethanol/de-ionized water (1/1, v/v)) was drop-casted on pristine copper substrates and dried overnight. The actual working area of cobalt and nickel deposition, immersed in the electrolyte, was 0.5 cm². A platinum wire, which was isolated from the bulk electrolyte by a glass body and porous CoralPor™ tip, was used as a counter electrode. A reference electrode of Ag/AgCl in 3 M NaCl was used. Electrochemical tests were carried out using linear sweep voltammetry and chronoamperometry using a potentio/galvanostat (VSP-300, Biologic) at ambient conditions. For the electrodeposition, 3 mL of the electrolyte, which contained CoCl₂ (CoSO₄) and/or NiCl₂ (NiSO₄) as metal sources in different background electrolytes (0.1 M Li₂SO₄, 0.1 M LiCl, and 10 M LiCl) were purged with nitrogen before the test. When using simulated solutions, the initial concentration of the binary cobalt/nickel was 10 mM or 100 mM; ensuring selectivity in diluted condition, albeit having limitations in mass-transfer and thus suffering from concentration polarization, gives this technique a broader applicability for various leaching design. In the linear sweep voltammetry test, the onset potential of electrodeposition was defined as the intersection of tangential lines of the horizontal background current (non-faradaic zone) and faradaic zone in the initial current increase.

### Example 2: Quantification of Electrodeposited Cobalt and Nickel

To recover the metals for elemental analysis, the electrodeposits were thoroughly washed with de-ionized water, and then digested using 10% w/w HNO₃. The amount of electrodeposited cobalt and nickel was quantified using inductively-coupled plasma optical emission spectroscopy (ICP-OES, Agilent 5110). 2% w/w HNO: was used to dilute samples of calibration standards or solutions generated after electrodeposition/digestion. Standard solutions of 100, 500, 1000, 5000 ppb cobalt/nickel were prepared by diluting the ICP calibration standard (cobalt/nickel standard for ICP TraceCERT®, 1000 mg/L in nitric acid, Sigma-Aldrich) with 2% w/W HNO3 (with 2% w/w HNOs being blank). After calibration, the linear fit was visualized, ensuring R² of >0.999 for every measurement. Each sample was measured with at least fifteen replicates by the spectrometer to yield a reliable averaged reading. From the ICP measurements, faradaic efficiencies of metal electrodeposition were determined by:

$$Faradaic efficiency = \frac{n \times M \times F}{{Q}_{total}} \times 100$$

where M (mol) is the sum of the amount of electrodeposited cobalt/nickel determined by ICP-OES, Fis the Faraday constant (96485 C mol⁻¹), Qₜₒₜₐₗ is the total charge passed through during the electrodeposition, and n is the number of electrons involved in cobalt/nickel electrodeposition. Considering that two electrons are involved either in direct deposition (Equation (1)) or through hydroxide formation (Equation (2) and (3)), n=2 was used for the determination of faradaic efficiency.

### Example 3: Stripping of Electrodeposited Cobalt and Nickel

After electrodeposition, the electrodeposit was transferred to a stripping electrolyte of 5 mM NaNO₃, whose pH was adjusted to 2.9˜3.0 using 12 M HCl. In this weak acid, a pristine copper foil exhibited equilibrium potential of −0.04˜+0.02 V (vs Ag/AgCl), thus applying −0.08 V did not lead to anodic copper dissolution but allow to anodically strip out the electrodeposited cobalt and nickel. Stripping was continued until the anodic current becomes lower than 10 pA. The amount of the recovered cobalt and nickel in the stripping electrolyte was measured using ICP-OES analysis. Also, the amount of remaining cobalt and nickel on the electrodeposit after the stripping was determined by digesting the deposit and quantifying using ICP-OES, as described above. Finally, stripping efficiencies were determined by:

$$Stripping efficiency = \frac{{m}_{stripped}}{{m}_{stripped} + {m}_{deposit}} \times 100$$

where m_{stripped} (mol) is the amount of stripped cobalt or nickel and m_{deposit} (mol) is the amount of remaining cobalt or nickel in the electrodeposit.

### Example 4: EQCM Analysis

The electrogravimetric analysis was carried out using the working electrode of 5 MHz quartz crystal coated with Cu, with a piezoelectroactive area of 0.2 cm² (diameter: 14 mm, polished finish, AW-R5CUP, Biologic). The counter electrode was a platinum wire, and all the potentials are referenced to Ag/AgCI (in 3 M NaCl) electrode. The frequency shift was measured using electrochemical quartz crystal microbalance (Biologic BluQCM QSD (QSD-TCU)). The mass increase was determined using Sauerbrey equation:

$$Δ f = \frac{- 2 {f}_{0}^{2} Δ m}{A \sqrt{{μ}_{i} {ρ}_{i}}} = - K Δ m$$

where f₀ is the resonant frequency of the quartz crystal, A is the piezoelectroactive area, pris the shear modulus of the quartz (2.947×10¹¹g cm⁻¹ s⁻²) and pris density of the quartz (2.648 g cm⁻³).

### Example 5: Characterizations

Materials characterizations were conducted in Frederick Seitz Materials Research Laboratory Central Research Facilities, University of Illinois. Surface morphology imaging and elemental mapping images after electrodeposition were obtained using a scanning electron microscope (SEM; Hitachi S-4700) operated at an accelerating voltage of 5 kV, equipped with energy dispersive X-ray spectroscopy (EDS; iXRF) with the accelerating voltage of 15 kV. The chemical states of cobalt and nickel on the electrodes were characterized using X-ray photoelectron spectroscopy (XPS; Kratos Axis ULTRA) with monochromatic Al Ka X-ray source (210 W). The XPS results were analyzed using CASA XPS software (UIUC license). X-ray fluorescence (Shimazdu EDX-7000 energy-dispersive X-ray fluorescence spectrometer) was run under helium atmosphere, using a rhodium target with accelerating potential up to 50 kV; integration times were 100 s and 500 s for qualitative-quantitative and quantitative scans, respectively. Ultralene film was used to support the samples, and collimator sizes were 3-10 mm. PCEDX-Navi software was used for data processing and analysis.

### Example 6: Pretreatment and Leaching of end-of-Life Spent LIBs

New 18650 batteries (Hohm Tech Life V4 18650 3015 mAh 22.1 A) were obtained from Hohm Tech. Following pretreatment steps were conducted before the electrochemical recovery was carried out:

(a) Discharging: The batteries were immersed in 10% (w/v) NaCl for 24hours to completely discharge. The remaining cell voltage was frequently monitored using a portable multimeter and full discharge was confirmed before manual disassembling.

(b) Dismantling: The batteries were manually disassembled using a saw and a sharp-nosed plier in a fume hood, and anode/cathode materials were uncurled for separation. The cathode scraps were cut into small pieces (1 cm×1 cm).

(c) NMP treatment: The cathode active materials were separated from aluminum current collector by employing N-methylpyrrolidine (NMP) as a solvent to dissolve polyvinylidene fluoride (PVDF) binder. The small pieces of cathode scraps were treated in NMP at 100° C. for 24 hours. Afterwards, the cathode materials were filtered and dried at 140° C.

(d) Leaching: All the leaching experiment were conducted in a 250 ml Erlenmeyer flask at room temperature. 30 mL of 10 M HCl was poured into the reactor. 4 g of the filtered cathode materials were then slowly added to the reactor and stirred continuously at 300 rpm for 2 hours. After leaching, the insoluble residue was separated by filtration, and the concentrations of Co, Ni, and Mn were determined using ICP-OES.

The subject-matter of this disclosure may relate to the following aspects, among others:

A first aspect relates to a method of selective electrodeposition for metal recycling, the method comprising: introducing a working fluid including first and second metal species into an electrochemical cell including: a working electrode having a surface coated with a positively charged polyelectrolyte; and a counter electrode spaced apart from the working electrode; adding a concentrated salt to the working fluid, the concentrated salt having a molar concentration in the working fluid of greater than 1 M, whereby oppositely charged complexes comprising the first and second metal species are formed; selecting one of the first and second metal species to be a targeted metal species for selective electrodeposition, the other of the first and second metal species being a non-targeted metal species; applying a cathodic potential that is more negative than a reduction potential of at least one of the first and second metal species to the working electrode; and selectively electrodepositing the targeted metal species on the working electrode, thereby producing an electrodeposit having an atomic ratio of the targeted metal species to the non-targeted metal species higher than that in the working fluid introduced into the electrochemical cell.

A second aspect relates to the method of the preceding aspect, wherein the electrodeposit has a targeted metal purity of at least about 75%, at least about 85%, or at least about 95%.

A third aspect relates to the method of any preceding aspect, wherein the cathodic potential is more negative than the reduction potentials of both the first and second metal species.

A fourth aspect relates to the method of any preceding aspect, wherein the cathodic potential is between the reduction potentials of the first and second metal species.

A fifth aspect relates to the method of any preceding aspect, wherein the cathodic potential is in a range from −0.55 V to −0.88 V.

A sixth aspect relates to the method of any preceding aspect, wherein the cathodic potential is in a range from −0.65 V to −0.88 V.

A seventh aspect relates to the method of any preceding aspect, wherein the positively charged polyelectrolyte is coated on the surface at a loading level of greater than zero and up to about 100 mg/m³.

An eighth aspect relates to the method of the seventh aspect, wherein the loading level of the positively charged polyelectrolyte is less than 1 mg cm², or less than 0.02 mg cm⁻².

A ninth aspect relates to the method of the seventh aspect, wherein the loading level of the positively charged polyelectrolyte is at least about 1 mg cm⁻², or at least about 5 mg cm⁻².

A tenth aspect relates to the method of any preceding aspect, wherein the positively charged polyelectrolyte is selected from the group consisting of: poly(diallyldimethylammonium chloride) (PDADMA), poly(vinylbenzyltrimethylammonium chloride (PVBTMAC), poly (acryloyloxyethyltrimethylammonium) (PAOEt), poly(2-(dimethylamino) ethyl methacrylate) (PDMAEMA), poly(4-N-methylvinylpyridinium chloride) (PVMPB), and poly(allylamine hydrochloride (PAH).

An eleventh aspect relates to the method of any preceding aspect, wherein the molar concentration of the concentrated salt is greater than 10 M.

A twelfth aspect relates to the method of any preceding aspect, wherein the concentrated salt comprises or takes the form of a halogenated salt, an ionic liquid, and/or a deep eutectic solvent.

A thirteenth aspect relates to the method of the twelfth aspect, wherein the concentrated salt comprises lithium chloride (LiCl).

A fourteenth aspect relates to the method of any preceding aspect, wherein, prior to the addition of the concentration salt, a reduction potential of the first metal species is within about 2% of a reduction potential of the second metal species.

A fifteenth aspect relates to the method of any preceding aspect, wherein, after the addition of the concentrated salt, the reduction potentials of the first and second metal species differ by at least about 10%.

A sixteenth aspect relates to the method of any preceding aspect, wherein each of the first metal species and the second metal species comprises a transition metal selected from the group consisting of: Ag, Au, Cd, Co, Cu, Cr, Fe, Hf, Hg, Ir, Lu, Mn, Mo, Nb, Ni, Os, Pd, Pt, Re, Rh, Ru, Sc, Ta, To, Ti, W, Y, Zn, and Zr.

A seventeenth aspect relates to the method of any preceding aspect, wherein the oppositely charged complexes comprise an anionic complex comprising the first metal species and a cationic complex comprising the second metal species.

An eighteenth aspect relates to the method of any preceding aspect, wherein the first metal species comprises cobalt ions and the second metal species comprises nickel ions.

A nineteenth aspect relates to the method of the eighteenth aspect, wherein the anionic complex comprises (CoCl₄²⁻) and the cationic complex comprises [Ni(H₂O)₅Cl]⁺.

A twentieth aspect relates to the method of the eighteenth or nineteenth aspect, wherein the second metal species is selected to be the targeted metal species, the first metal species being the non-targeted metal species, wherein the cathodic potential is between about −0.55 V and −0.60 V, and wherein the positively charged polyelectrolyte is coated on the surface at a loading level of at least 1 mg cm⁻².

A twenty-first aspect relates to the method of the eighteenth or nineteenth aspect, wherein the first metal species is selected to be the targeted metal species, the second metal species being the non-targeted metal species, wherein the cathodic potential is between about −0.65 V and −0.88 V, and wherein the positively charged polyelectrolyte is coated on the surface at a loading level of less than 1 mg cm⁻².

A twenty-second aspect relates to the method of any preceding aspect, further comprising, after the selective electrodeposition, conducting a stripping or regeneration process whereby the first metal ions and the second metal ions are removed from the working electrode and captured in a stripping solution comprising an acid.

A twenty-third aspect relates to the method of the twenty-second aspect, wherein the stripping or regeneration process further comprises, while the working and counter electrodes are in contact with the stripping solution, applying an anodic potential that is more positive than the reduction potential of the first and second metal species to the working electrode.

A twenty-fourth aspect relates to the method of the twenty-second or twenty-third aspect, further comprising, after the stripping or regeneration process, utilizing the stripping solution as the working fluid, and repeating the introduction of the working fluid into the electrochemical cell, the addition of the concentrated salt to the working fluid, and the application of the cathodic potential to the working electrode, thereby selectively electrodepositing the targeted metal species onto the working electrode.

A twenty-fifth aspect relates to the method of the twenty-fourth aspect, further comprising carrying out the stripping or regeneration process followed by the selective electrodeposition two or more times.

A twenty-sixth aspect relates to the method of any preceding aspect, wherein, after the selective electrodeposition, the working fluid is a depleted working fluid having a higher atomic ratio of the non-targeted metal species to the targeted metal species in comparison with the working fluid introduced into the electrochemical cell.

A twenty-seventh aspect relates to the method of the twenty-sixth aspect, further comprising, after the selective electrodeposition, introducing the depleted working fluid into a second electrochemical cell for selective electrodeposition of the non-targeted metal species, the second electrochemical cell including: a second working electrode having a surface coated with a positively charged polyelectrolyte; and a second counter electrode spaced apart from the second working electrode; and applying a cathodic potential that is more negative than a reduction potential of the non-targeted metal species to the second working electrode; and selectively electrodepositing the non-targeted metal species on the second working electrode, thereby producing a second electrodeposit having an atomic ratio of the non-targeted metal species to the targeted metal species higher than that of the depleted working fluid introduced into the second electrochemical cell.

A twenty-eighth aspect relates to the method of any preceding aspect, the method being carried out at ambient temperature without heating.

A twenty-ninth aspect relates to the method of any preceding aspect, the method being a batch process, wherein a discrete volume of the working fluid is introduced to the electrochemical cell.

A thirtieth aspect relates to the method of any preceding aspect, the method being a continuous process wherein a continuous stream of the working fluid is introduced into and flowed through the electrochemical cell.

A thirty-first aspect relates to the method of any preceding aspect, wherein the working fluid comprises a waste fluid derived from industrial manufacturing, spent batteries, and/or mining operations.

A thirty-second aspect relates to the method of any preceding aspect, the method further comprising, prior to introducing the working fluid into the electrochemical cell, preparing the working fluid from a spent battery.

A thirty-third aspect relates to the method of the thirty-second aspect, wherein the preparing comprises: discharging the spent battery; dismantling the spent battery to obtain a current collector including a cathode active material; employing a solvent to release the cathode active material from the current collector; leaching the cathode active material with an acid to form the working fluid.

A thirty-fourth aspect relates to the method of the thirty-third aspect, the method further comprising, after leaching, adjusting a pH of the working fluid to be about 3.

A thirty-fifth aspect relates to a system for selective electrodeposition for metal recycling, the system comprising: an electrochemical cell including: a fluid including first and second transition metals and a salt at a molar concentration of greater than 1 M; a working electrode in contact with the fluid, the working electrode having a surface coated with a positively charged polyelectrolyte; and a counter electrode in contact with the fluid and spaced apart from the working electrode; and a power supply electrically connected to the working and counter electrodes.

A thirty-sixth aspect relates to the system of the preceding aspect, wherein the positively charged polyelectrolyte is coated on the surface at a loading level of greater than zero and up to about 100 mg/m³.

A thirty-seventh aspect relates to the system of the thirty-sixth aspect, wherein the loading level of the positively charged polyelectrolyte is less than 1 mg cm⁻², or less than 0.02 mg cm⁻².

A thirty-eighth aspect relates to the system of the thirty-sixth aspect, wherein the loading level of the positively charged polyelectrolyte is at least about 1 mg cm⁻², or at least about 5 mg cm².

A thirty-ninth aspect relates to the system of any preceding aspect, wherein the positively charged polyelectrolyte is selected from the group consisting of: poly(diallyldimethylammonium chloride) (PDADMA), poly(vinylbenzyltrimethylammonium chloride (PVBTMAC), poly (acryloyloxyethyltrimethylammonium) (PAOEt), poly(2-(dimethylamino) ethyl methacrylate) (PDMAEMA), poly(4-N-methylvinylpyridinium chloride) (PVMPB), and poly(allylamine hydrochloride (PAH).

A fortieth aspect relates to the system of any preceding aspect, wherein the molar concentration of the concentrated salt is greater than 10 M.

A forty-first aspect relates to the system of any preceding aspect, wherein the concentrated salt comprises or takes the form of a halogenated salt, an ionic liquid, and/or a deep eutectic solvent.

A forty-second aspect relates to the system of any preceding aspect, wherein the concentrated salt comprises lithium chloride (LiCl).

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A method of selective electrodeposition for metal recycling, the method comprising:
introducing a working fluid including first and second metal species into an electrochemical cell including: a working electrode having a surface coated with a positively charged polyelectrolyte; and a counter electrode spaced apart from the working electrode;
adding a concentrated salt to the working fluid, the concentrated salt having a molar concentration in the working fluid of greater than 1 M, whereby oppositely charged complexes comprising the first and second metal species are formed;
selecting one of the first and second metal species to be a targeted metal species for selective electrodeposition, the other of the first and second metal species being a non-targeted metal species;
applying a cathodic potential that is more negative than a reduction potential of at least one of the first and second metal species to the working electrode; and
selectively electrodepositing the targeted metal species on the working electrode, thereby producing an electrodeposit having an atomic ratio of the targeted metal species to the non-targeted metal species higher than that in the working fluid introduced into the electrochemical cell.

2. The method of claim 1, wherein the electrodeposit has a targeted metal purity of at least about 75%.

3. The method of claim 1, wherein the cathodic potential is more negative than the reduction potentials of both the first and second metal species.

4. The method of claim 1, wherein the cathodic potential is between the reduction potentials of the first and second metal species.

5-6. (canceled)

7. The method of claim 1, wherein the positively charged polyelectrolyte is coated on the surface at a loading level of greater than zero and up to about 100 mg/m³.

8-10. (canceled)

11. The method of claim 1, wherein the molar concentration of the concentrated salt is greater than 10 M.

12. The method of claim 1, wherein the concentrated salt comprises or takes the form of a halogenated salt, an ionic liquid, and/or a deep eutectic solvent.

13. (canceled)

14. The method of claim 1, wherein, prior to the addition of the concentration salt, a reduction potential of the first metal species is within about 2% of a reduction potential of the second metal species.

15. The method of claim 1, wherein, after the addition of the concentrated salt, the reduction potentials of the first and second metal species differ by at least about 10%.

16. The method of claim 1, wherein each of the first metal species and the second metal species comprises a transition metal selected from the group consisting of: Ag, Au, Cd, Co, Cu, Cr, Fe, Hf, Hg, Ir, Lu, Mn, Mo, Nb, Ni, Os, Pd, Pt, Re, Rh, Ru, Sc, Ta, Tc, Ti, W, Y, Zn, and Zr.

17-19. (canceled)

20. The method of claim 1, wherein the first metal species comprises cobalt ions and the second metal species comprises nickel ions.
wherein the second metal species is selected to be the targeted metal species, the first metal species being the non-targeted metal species,
wherein the cathodic potential is between about −0.55 V and −0.60 V, and
wherein the positively charged polyelectrolyte is coated on the surface at a loading level of at least 1 mg cm⁻².

21. The method of claim 1, wherein the first metal species comprises cobalt ions and the second metal species comprises nickel ions,
wherein the first metal species is selected to be the targeted metal species, the second metal species being the non-targeted metal species,
wherein the cathodic potential is between about −0.65 V and −0.88 V, and
wherein the positively charged polyelectrolyte is coated on the surface at a loading level of less than 1 mg cm⁻².

22. The method of claim 1, further comprising, after the selective electrodeposition, conducting a stripping or regeneration process whereby the first metal ions and the second metal ions are removed from the working electrode and captured in a stripping solution comprising an acid.

23-25. (canceled)

26. The method of claim 1, wherein, after the selective electrodeposition, the working fluid is a depleted working fluid having a higher atomic ratio of the non-targeted metal species to the targeted metal species in comparison with the working fluid introduced into the electrochemical cell.

27. The method of claim 26, further comprising, after the selective electrodeposition, introducing the depleted working fluid into a second electrochemical cell for selective electrodeposition of the non-targeted metal species, the second electrochemical cell including: a second working electrode having a surface coated with a positively charged polyelectrolyte; and a second counter electrode spaced apart from the second working electrode; and
applying a cathodic potential that is more negative than a reduction potential of the non-targeted metal species to the second working electrode; and
selectively electrodepositing the non-targeted metal species on the second working electrode, thereby producing a second electrodeposit having an atomic ratio of the non-targeted metal species to the targeted metal species higher than that of the depleted working fluid introduced into the second electrochemical cell.

28-30. (canceled)

31. The method of claim 1, wherein the working fluid comprises a waste fluid derived from industrial manufacturing, spent batteries, and/or mining operations.

32-24. (canceled)

35. A system for selective electrodeposition for metal recycling, the system comprising:
an electrochemical cell including:
a fluid including first and second transition metals and a salt at a molar concentration of greater than 1 M;
a working electrode in contact with the fluid, the working electrode having a surface coated with a positively charged polyelectrolyte; and
a counter electrode in contact with the fluid and spaced apart from the working electrode; and
a power supply electrically connected to the working and counter electrodes.

36-38. (canceled)

39. The system of claim 35, wherein the positively charged polyelectrolyte is selected from the group consisting of:
poly(diallyldimethylammonium chloride) (PDADMA), poly(vinylbenzyltrimethylammonium chloride (PVBTMAC), poly (acryloyloxyethyltrimethylammonium) (PAOEt), poly(2-(dimethylamino) ethyl methacrylate) (PDMAEMA), poly(4-N-methylvinylpyridinium chloride) (PVMPB), and poly(allylamine hydrochloride (PAH).

40. The system of claim 35, wherein the molar concentration of the concentrated salt is greater than 10 M.

41. The system of claim 35, wherein the concentrated salt comprises or takes the form of a halogenated salt, an ionic liquid, and/or a deep eutectic solvent.

42. (canceled)
